(19) United States
(12) Patent Application Publication
(10) Pub. No.: US 2010/0243105 A1
(43) Pub. Date: Sep. 30, 2010

(54) Tool for filling a gearbox with lubricant

(76) Inventor: Ricky D. McGee, Gretna, NE (US)

Correspondence Address: THOMTE LAW OFFICE, L.L.C., 2120 S. 72ND STREET, SUITE 1111, OMAHA, NE, 68124, US

(21) Appl. No.: 12/384,002

(22) Filed: Mar. 31, 2009

(51) Int. Cl. B67C 11/04

(52) U.S. Cl. 141/334; 141/345

(57) ABSTRACT

A tool is provided for filling a gearbox with lubricant. The tool includes structure which prevents the gearbox from being over filled with lubricant. The tool of this invention enables access to the fill opening of the gearbox and prevents spillage or leakage. The tool is ideally suited for use with a gearbox mounted on the drive unit of a mechanized irrigation system.

### BACKGROUND OF THE INVENTION

1. Field of the Invention

This invention relates to a tool for filling a gearbox with lubricant and more particularly to the tool for filling a gearbox, mounted on a drive unit of a mechanized irrigation system, with liquid lubricant.

2. Description of the Related Art

In mechanized irrigation systems such as a center pivot irrigation system, the water pipeline is propelled around a field by a plurality of spaced-apart drive units or towers with each of the drive units having a pair of driven wheels. Normally, a gearbox is associated with each of the drive wheels with the gearboxes being driven by an electric motor or the like. The gearbox is filled with a liquid lubricant and it is extremely important that the lubricant in the gearbox be maintained at the proper level. Prior to the instant invention, the filling of the gearbox with lubricant required the use of long funnels of hoses to direct the flow of lubricant to the fill hole of the gearbox with the fill hole being at a location having limited access because of the associated drive wheel. The fill holes on some gearboxes are difficult to fill using common equipment. When a gearbox becomes full, any extra lubricant in the funnel being used may leak as it is removed from the fill hole. If the gearbox is overfilled with lubricant, the reduced air volume within the gearbox may cause increased pressure inside the gearbox and force lubricant through the seals of the gearbox creating a leak.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A tool for filling a gearbox mounted on a drive unit of a mechanized irrigation system with liquid lubricant is disclosed with the gearbox having a fill hole extending horizontally thereinto below the upper end thereof. The tool of this invention comprises a funnel-like member having an open upper end with a discharge opening at the lower end thereof. A generally vertically disposed first hollow tubular portion, having open upper and lower ends, extends downwardly from the discharge opening of the funnel-like member. A generally horizontally disposed second hollow tubular portion is in communication with the lower end of the first tubular portion. The second tubular portion has a downwardly presented first discharge opening formed therein inwardly of the closed outer end thereof. A third hollow tubular portion, having inner and outer ends, is selectively rotatably mounted on the second tubular portion. The third tubular portion has a second discharge opening formed therein. The second and third tubular portions are adapted to be inserted into the fill opening of the gearbox to seal the fill opening. The second discharge opening is in fluid communication with the first discharge opening when the third tubular portion is rotated to a fill position with respect to the second tubular portion. The second discharge opening is out of fluid communication with the first discharge opening when the third tubular portion is rotated to a fluid shut-off position with respect to the second tubular portion.

In the preferred embodiment, the center of the funnel-like member is laterally offset with respect to the first tubular portion so that the tool may be easily used adjacent the tire of the drive unit.

When the second and third tubular portions are inserted into the fill opening of the gearbox, lubricant is placed into the funnel-like member if lubricant has not been previously placed therein. The third tubular portion is then rotated with respect to the second tubular portion so that the first and second discharge openings in the second and third tubular portions respectively are in register with one another. The design of this invention permits lubricant to only reach the full level and prevents over filling. This is achieved by the location of the first discharge opening. During the filling of the lubricant, the lubricant level will only rise to the bottom of the first discharge opening. At that point, air cannot escape from the gearbox and additional lubricant will not flow into the gearbox, thus preventing over filling. Because the gearbox cannot be over filled with lubricant, the air volume therein will be maintained. Pressure will not be increased and lubricant will not be forced through the seals thereby creating leaks.

It is therefore a principal object of the invention to provide an improved tool for filling a gearbox with lubricant.

A further object of the invention is to provide a tool for filling a gearbox with lubricant with the gearbox being mounted on a drive unit of a mechanized irrigation system.

A further object of the invention is to provide a tool for filling a gearbox with lubricant which ensures that the gearbox will not be over filled with lubricant.

A further object of the invention is to provide a tool for filling a gearbox with lubricant which prevents spillage of the lubricant.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of a conventional mechanized irrigation system on which gearboxes are mounted for driving the drive wheels of the drive units;

FIG. 2 is a partial perspective view illustrating a typical gearbox employed on a drive unit of a mechanized irrigation system;

FIG. 3 is a perspective view of the tool of this invention;

FIG. 4 is a partial exploded perspective view of a portion of the tool of this invention;

FIG. 5 is an exploded perspective view of the tool of this invention;

FIG. 6 is a side view of the tool of this invention with the tool being in the “off” or closed position;

FIG. 7 is a partial sectional view illustrating the tool of this invention being in its closed or shut-off position; and

FIG. 8 is a view similar to FIG. 7 except that the tool has been rotated so that fluid may be discharged from the funnel-like member.

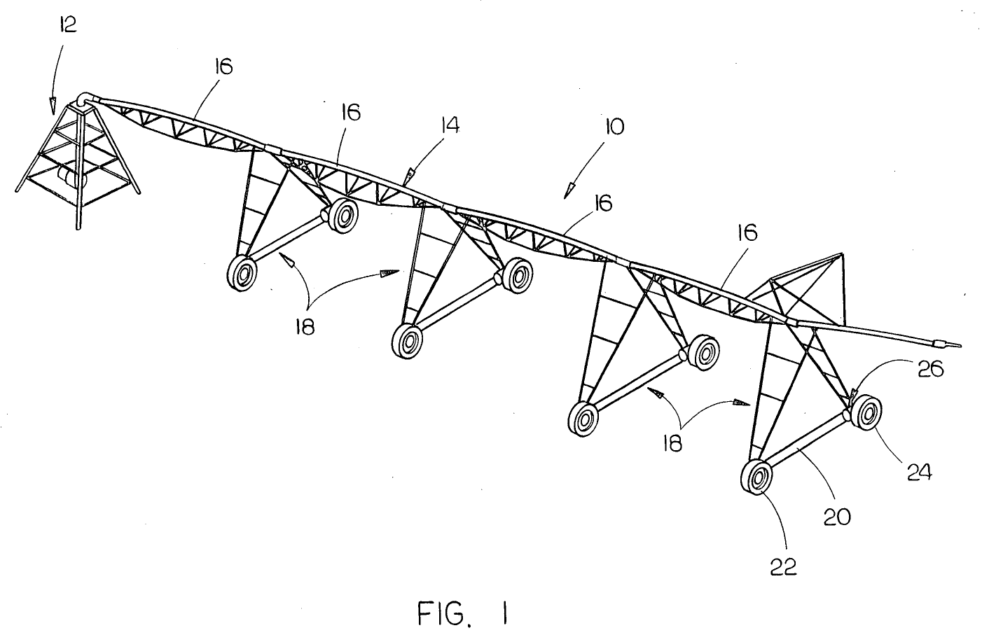

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The numeral 10 refers generally to a mechanized irrigation system such as a center pivot irrigation system. The system 10 conventionally includes a center pivot structure 12 having a main water pipeline 14 extending outwardly therefrom. The pipeline 14 includes a plurality of span structures. Each of the drive units 18 includes a main beam 20 having drive wheels 22 and 24 rotatably mounted on the opposite ends thereof. Usually, a gearbox 26 is provided for each of the drive wheels 22 and 24 with the gearboxes 26 being driven by an electric motor so that the irrigation system may be propelled through the field about the center pivot structure. Although a center pivot irrigation system 10 is illustrated, the gearbox lubricant fill tool of this invention may be employed on other mechanized irrigation systems such as a linear move irrigation system, a corner irrigation system, etc.

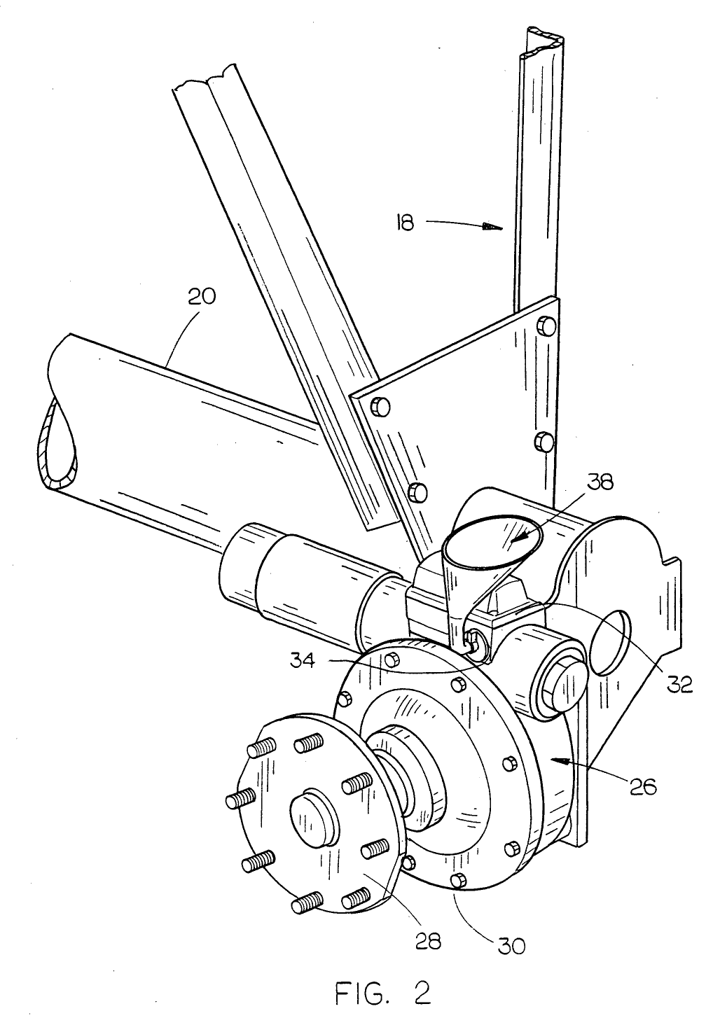

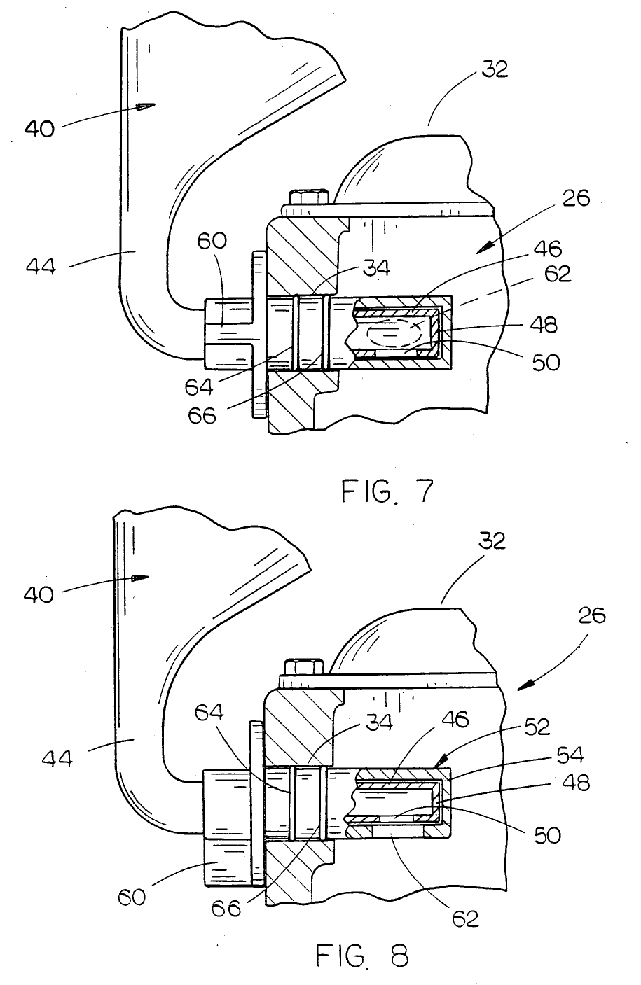

FIG. 2 illustrates a typical gearbox 26 to which the drive wheel hub 28 is attached. The gearbox 26 includes a lower end 30 and an upper end 32. Gearbox 26 includes a selectively closable lubricant fill opening 34 which extends horizontally into the gearbox 26 as seen in FIGS. 7 and 8. As seen in FIGS. 2, 7 and 8, the fill opening 34 is formed in gearbox 26 below the upper end thereof.

The fill tool of this invention is refined to generally by the reference numeral 38. Tool 38 includes a funnel-like member 40 having an open upper end 42. The lower end of member 40 is open and has a first hollow tubular portion 44 extending downwardly therefrom in an offset relationship with respect to the center of the funnel-like member 40 as best seen in FIG. 6. A second hollow tubular portion 46 is in fluid communication with the lower end of first tubular portion 44 and extends horizontally therefrom. The end 48 of tubular portion 46 is closed as seen in FIGS. 7 and 8. Tubular portion 46 has a downwardly presented discharge opening 50 formed therein adjacent the closed end 48.

The numeral 52 refers to a third hollow tubular portion having a closed end 54 and an open outer end 56. A circular disc 58 is formed with tubular portion 52 and extends transversely outwardly therefrom as seen in FIG. 4. Rotation or actuation lever 60 is also formed with tubular portion 52 and disc 58 and extends radially therefrom. Tubular portion 52 has an opening 62 formed therein adjacent inner end 54 and which is axially or radially aligned with lever 60 to assist the operator in visually determining the rotational position of opening 62 by simply lo observing the position of lever 60. A pair of O-ring seals 64 and 66 embrace annular grooves formed in tubular portion 52.

Tubular portion 52 selectively rotatably embraces tubular portion 46 as illustrated in the drawings. Tubular portion 52 is selectively rotatable from a first “closed” position wherein opening 62 is out of register with opening 50 in tubular portion 46 (FIG. 7) to a second “open” or fill position wherein opening 62 registers with opening 50 (FIG. 8).

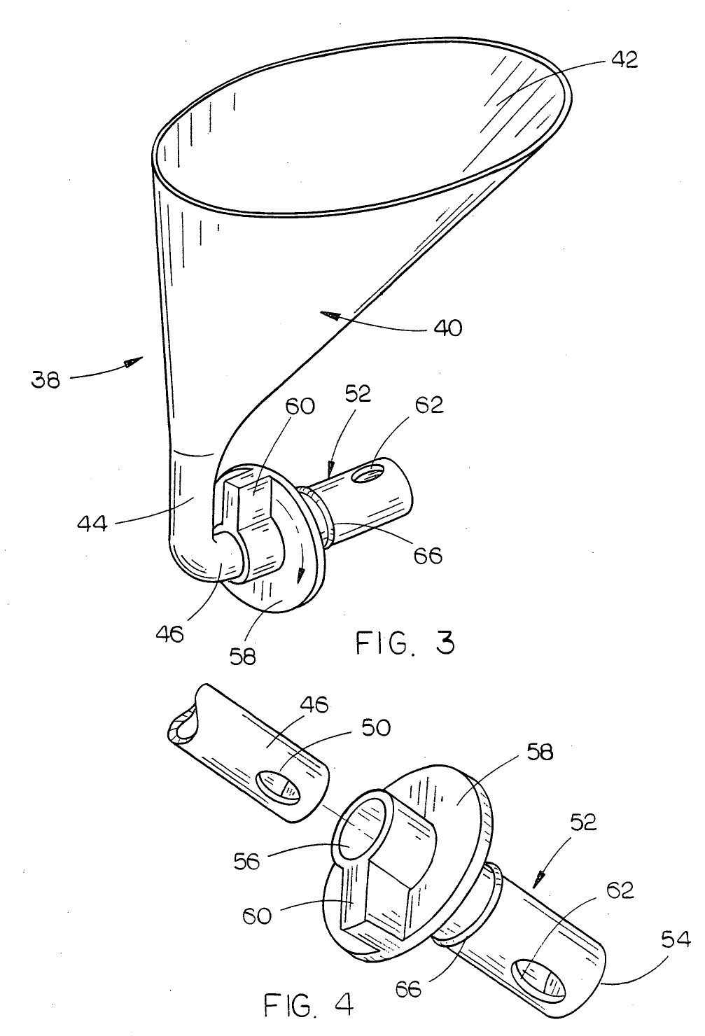

The method of using the tool of this invention is as follows. When it is desired to fill the gearbox 26 with lubricant, the plug closing the fill opening 34 is removed. The lever 60 on the tubular portion 52 is rotated to the position of FIG. 3 so that the opening 62 does not communicate with the discharge opening 48 in tubular portion 46. The funnel-like member 42 is then filled with liquid lubricant. The tool 38 is then maneuvered so that the tubular portion 52, which has the tubular portion 46 contained therein, is inserted into the fill opening 34 so that disc 58 embraces the outer surface of the upper end of the gearbox 28 as illustrated in FIG. 2.

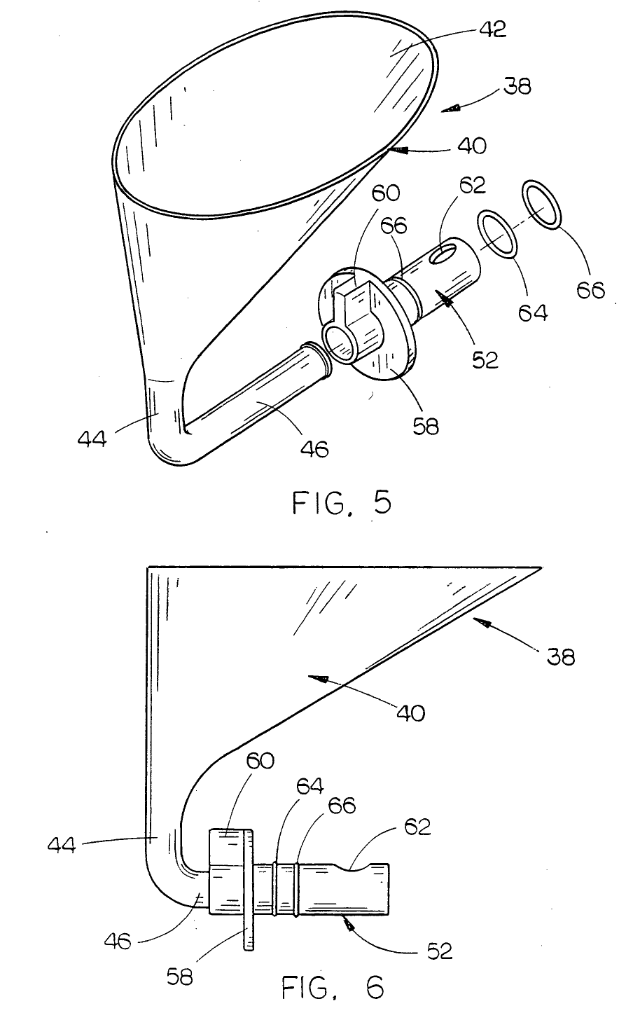

The tubular portion 52 is then rotated from the position of FIG. 5 to the position of FIG. 8 so that discharge opening 62 registers with discharge opening 48 as seen in FIG. 8. The lubricant contained within the funnel-like member 42 will then flow into the upper end of the gearbox through the openings 50 and 62. When the lubricant level reaches discharge opening 62, further lubricant will not flow into the interior of the gearbox thereby ensuring that the gearbox will not be overfilled. When the gearbox has been suitably filled with lubricant, the tubular portion 52 will be rotated from the position of FIG. 8 to either the position of FIG. 7 or to the position of FIG. 5 with the attitude of the lever 60 indicating the relative position of the opening 62 with respect to the opening 50.

When the tubular portion 52 has been rotated to either the position of FIG. 7 or the position of FIG. 5, the tool 38 is moved laterally with respect to the fill opening 34 so that the tubular portion 52 is removed from the fill opening 34 with the plug, which normally closes the fill opening 34, then being replaced into the fill opening.

It can therefore be seen that a tool has been provided for filling a gearbox mounted on a mechanized irrigation system to be conveniently filled with lubricant and which prevents spillage of lubricant and which also prevents the gearbox from being overfilled with lubricant.

It can therefore be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A tool for filling a gearbox with lubricant with the gearbox being mounted on a drive unit of a mechanized irrigation system, the gearbox having upper and lower ends and with a fill hole extending horizontally thereinto below the upper end thereof, comprising:
a funnel-like member having an open upper end with a discharge opening at the lower end thereof;
a generally vertically disposed first hollow tubular portion, having open upper and lower ends;
said open upper end of said first tubular portion being in fluid communication with said discharge opening at the lower end of said funnel-like member;
a generally horizontally disposed second hollow tubular portion having an open first end and a closed second end;
said open first end of said second tubular portion being in fluid communication with said open lower end of said first tubular portion;
said second tubular portion having a downwardly presented first discharge opening formed therein adjacent said closed second end thereof;
a third hollow tubular portion, having first and second ends, selectively rotatably embracing said second tubular portion;
said third tubular portion having a second discharge opening formed therein;
said third and second tubular portions being adapted to be inserted into the fill opening of the gearbox to seal the fill opening;
said second discharge opening being in fluid communication with said first discharge opening when said third tubular portion is rotated to a fill position with respect to said second tubular portion;
said second discharge opening being out of fluid communication with said first discharge opening when said third tubular portion is rotated to a fluid shut-off position with respect to said second tubular portion.

2. The tool of claim 1 wherein the center of said funnel-like member is laterally offset with respect to said first tubular portion.

3. The tool of claim 1 wherein an elbow-shaped tubular portion fluidly connects said first and second tubular portions.

4. The tool of claim 1 wherein said third tubular portion has a rotation lever extending therefrom to assist a person to rotate said third tubular portion with respect to said first tubular portion.

5. The tool of claim 4 wherein said lever is axially aligned with said second discharge opening formed in said third tubular portion.

6. The tool of claim 1 wherein an annular seal is positioned on said second tubular portion which sealably engages the interior of said third tubular portion.

7. The tool of claim 6 wherein an annular seal means embraces said third tubular portion for sealably engaging the gearbox around said fill opening.
